(19) United States
(12) Patent Application Publication
(10) Pub. No.: US 2011/0197854 A1
(43) Pub. Date: Aug. 18, 2011

(54) FUEL CONTROL APPARATUS

(76) Inventor: Roger Hall, Marysville, WA (US)

(21) Appl. No.: 12/707,181

(22) Filed: Feb. 17, 2010

(51) Int. Cl. F02M 69/04

(52) U.S. Cl. 123/445

(57) ABSTRACT

The invention, described herein, is an improved Fuel Injection Servo (“Servo”) for the homebuilt aircraft. The Servo has been designed to allow the manufacturer to more easily fine tune the pressure deferential over the air diaphragm. The Servo also provides an idle valve that the manufacturer and homebuilder can easily fine tune. In a second embodiment, the Servo is further adapted to replace the carburetor in smaller aircraft.

### CROSS-REFERENCES TO RELATED APPLICATIONS

### Statement Regarding Federally Sponsored Research or Development

Not Applicable

### INCORPORATION-BY-REFERENCE OF MATERIAL SUBMITTED ON A COMPACT DISC

Not Applicable

### COPYRIGHT NOTICE

This document contains information subject to copyright protection. The copyright owner has no objection to the facsimile reproduction of anyone of the patent document or the patent, as it appears in the US Patent and Trademark Office Files or records but otherwise reserves all copyrights whatsoever.

### FIELD OF INVENTION

This invention relates to a fuel injection system, and more particularly a fuel injection servo for an internal combustion engine.

### BACKGROUND

Experimental aircraft is a term used to refer to aircraft which have not been proven fully in flight. However, experimental aircraft has become a common reference for homebuilt aircraft. Experimental homebuilt aircraft (“homebuilt aircraft”) are constructed by a homebuilder; that is, homebuilt aircraft are not built by a licensed aircraft manufacturer. Generally, about 51% of a homebuilt aircraft is constructed by a private individual; the remaining portion of homebuilt aircraft is usually from a kit that is assembled by a manufacturer. The fuel injection system of a homebuilt aircraft is bought from the manufacturer.

Homebuilt, or any other aircraft, have either a Multi-Point Injection System (“MPIS”) or a carburetor. Smaller aircraft commonly have a carburetor. In a MPIS one injector supplies fuel directly to a cylinder of the engine. In a Single-Point Fuel Injection System (“SPIS”), fuel is injected at a single place and then distributed to each cylinder of the engine.

Fuel injection systems are designed to meter fuel in direct ratio to the volume of air being consumed by the engine at any given time. Generally, an engine driven pump receives fuel from the fuel tank and supplies that fuel to a fuel injection servo. Fuel injection servos are well known in the art. The “RSA Fuel Injection System, Training Manual” written by Precision Airmotive Corporation, is hereby incorporated, in its entirety, by reference.

Fuel injection servos are tuned in the factory before shipment to the homebuilder. However, because homebuilt aircraft come in varying sizes, the fuel injection servo may need to be fine tuned for optimal results. A fuel injection servo will get peak performance when a maximum air pressure differential signal is received by the inlet of the servo. Prior to leaving the factory, a fuel injection servo is tuned to a standard differential air pressure. Because of tolerances allowed in manufacture of the servos, the shape of the venturi (500) will have minor variance.

FIGS. 1 and 1A show a fuel injection servo known in the art. The size of the venturi is definite. To obtain a standard differential air pressure, the venturi will sometimes be filed down by hand. Once the shape of the venture is changed, its performance can only be verified with the proper airflow equipment. This cannot be done in the field.

Referring to FIG. 2, the idle valve is connected to the throttle linkage. The idle valve effectively reduces the area of the main metering jet for accurate metering of the fuel in the idle range. The idle control valve is opened/closed by rotating a flat metal plate over the valve's opening. As with any mechanical function that creates a metal on metal situation, the idle control valve starts to wear.

Referring to FIG. 3, to ensure that the idle valve is properly seals, a strong spring is used to hold the valve in place. To fine tune the idle valve, the spring must be changed. When the idle valve bears a higher load, caused by the spring, the idle valve tends to wear quicker.

Fuel injection servos for homebuilt aircraft are normally MPIS. Smaller aircraft generally have carburetors. The carburetor has several deficiencies. First, carburetor icing becomes a problem. Carburetor icing is caused by a change in temperature due to fuel vaporization prior to entering the carburetor. Vaporizing fuel can also cause the throttle valve of the carburetor to freeze. This scenario leaves the engine without air. The homebuilder can manage this weakness in the carburetor by installing a heating device for the carburetor. However, small aircraft may not have room for a heating device. Further, heating devices cause power loss and need constant pilot attention. Second, carburetors are sensitive normal operations. Third, it is difficult to adjust a carburetor to optimize fuel flow. Finally, an aircraft cannot fly upside down with a carburetor because airflow through the carburetor can go only one direction. Replacing a carburetor with a fuel injection system would solve these problems. However, a MPIS does not exit for smaller planes. Conceivably, the MPIS could be adapted, after market, for the smaller aircraft. However, a better solution is a SPIS which is made for the smaller aircraft.

Another problem that smaller aircraft face is delayed response at sudden throttle opening or acceleration. This is a natural occurrence in smaller aircraft because the fuel discharge point is further away from the cylinders.

The invention, described herein, is an improved Fuel Injection Servo (“Servo”) for the homebuilt aircraft. The Servo has been designed to allow the manufacturer to more easily fine tune the pressure deferential over the air diaphragm. The Servo also provides an idle valve that the manufacturer and homebuilder can easily fine tune. In a second embodiment, the Servo is further adapted to replace the carburetor in smaller aircraft.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is a top elevation view of a fuel injection servo known in the art;

FIG. 1A shows cross-section I-I taken from FIG. 1;

FIG. 2 is a schematic view showing the relationship of idle valve to the throttle linkage;

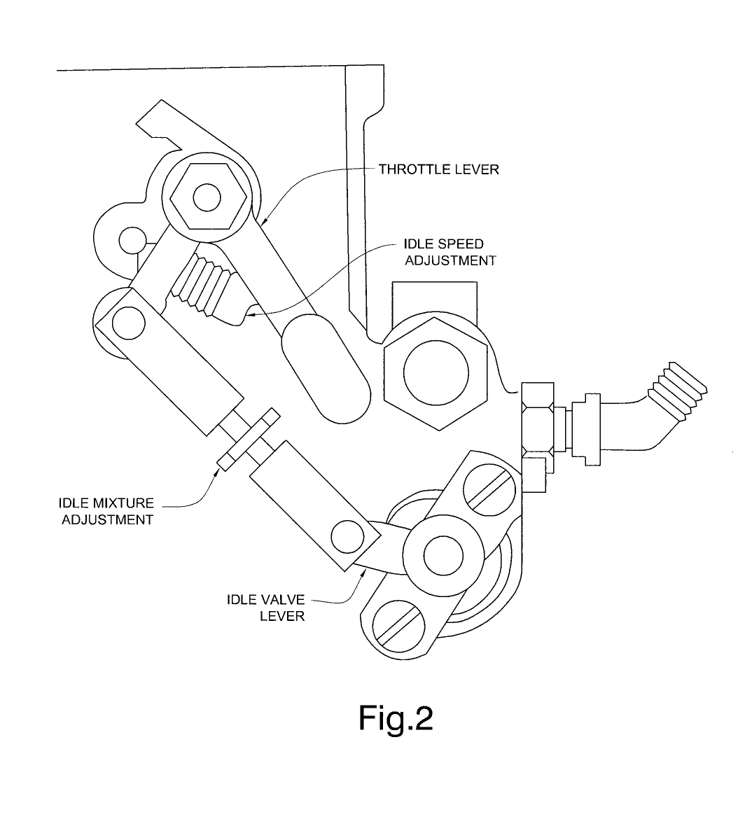

FIG. 3 shows a side view of a fuel injection servo known in the art;

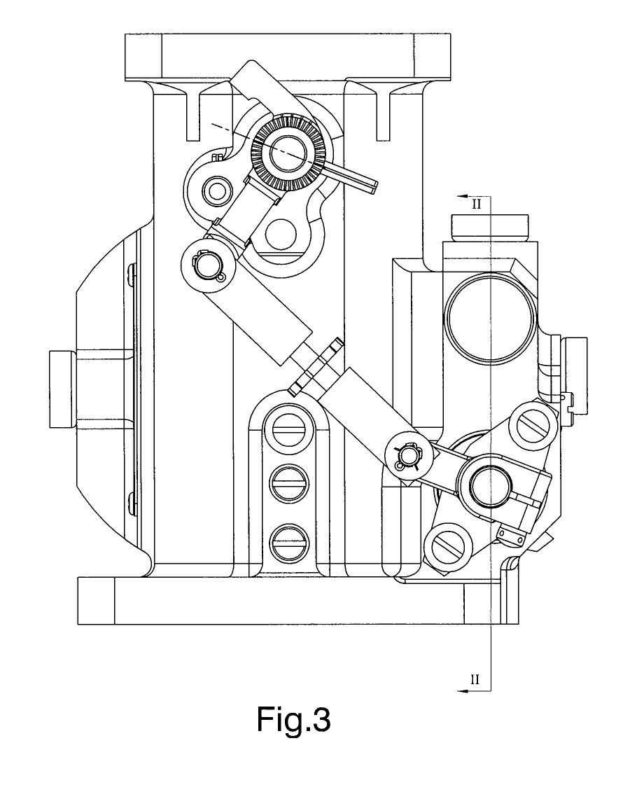

FIG. 3A shows cross-section II-II taken from FIG. 3;

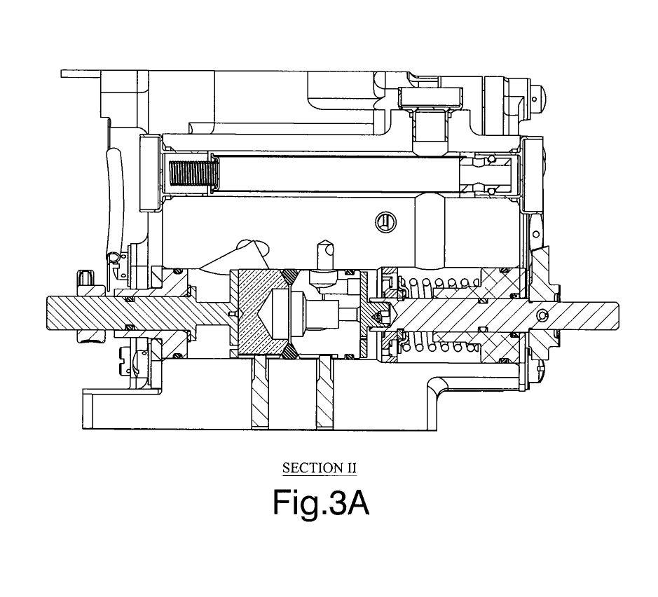

FIG. 4 is an elevation view of the inventive fuel injection servo;

FIG. 5 is an end view of the inventive fuel injection system;

FIG. 6 is an exploded view of the idle valve for a fuel injection servo known in the art;

FIG. 7 is an exploded view of the idle valve for the inventive fuel injection servo;

FIG. 8 is a schematic of the fuel system;

FIG. 9 is an end view of the inventive fuel injection servo;

FIG. 9A shows cross-section III-III taken from FIG. 9;

FIG. 10 is a side view of the inventive fuel control apparatus;

FIG. 10A shows cross-section IV-IV taken from FIG. 10;

FIG. 11 is a side view of the inventive fuel injection servo;

FIG. 11A shows cross-section V-V taken from FIG. 11.

### DETAILED DESCRIPTION OF THE INVENTION

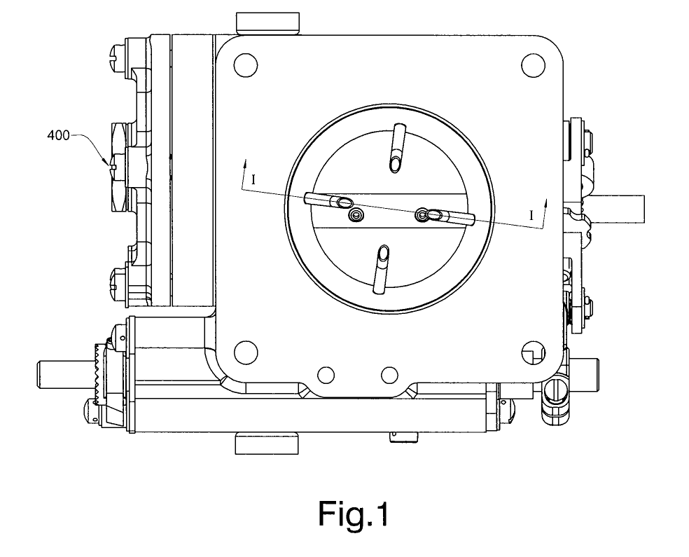

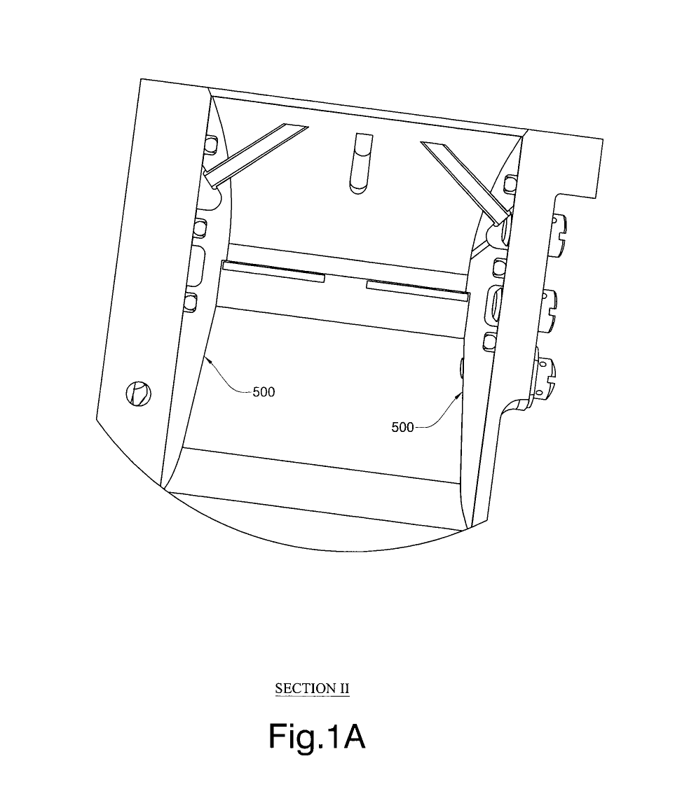

In the description of the invention above and in the detailed description of the invention, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally. Referring now in detail to the FIGS. 1 though 11A, wherein the same numbers are used where applicable, a fuel control apparatus, namely a Servo, constructed in accordance with an embodiment of the invention is identified generally as the reference number 100. Although the description below anticipates the Servo (100) will be used on homebuilt aircraft, it will be obvious to those skilled in the art that the Servo (100) can be used on any type of aircraft and generally, on any combustion engine of appropriate size.

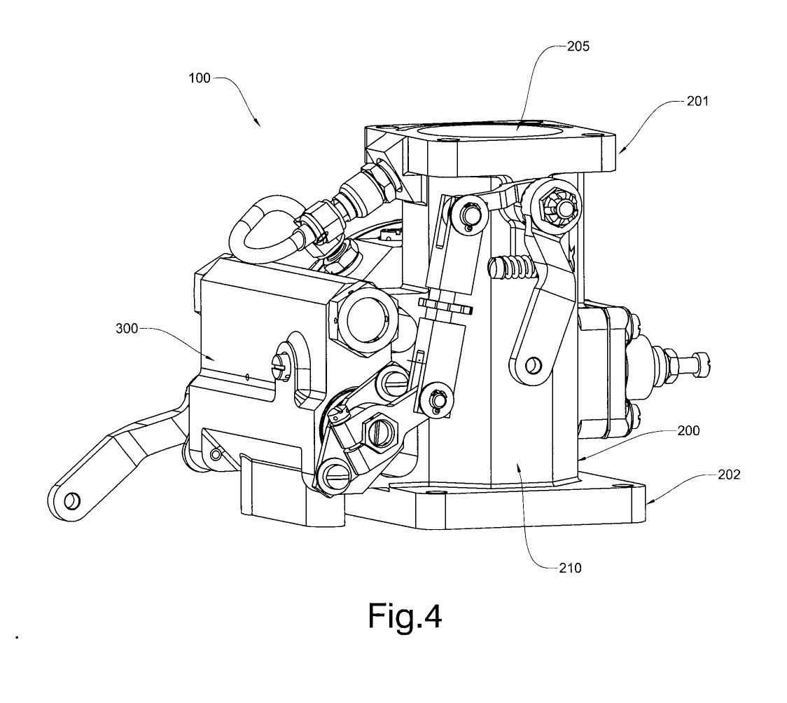

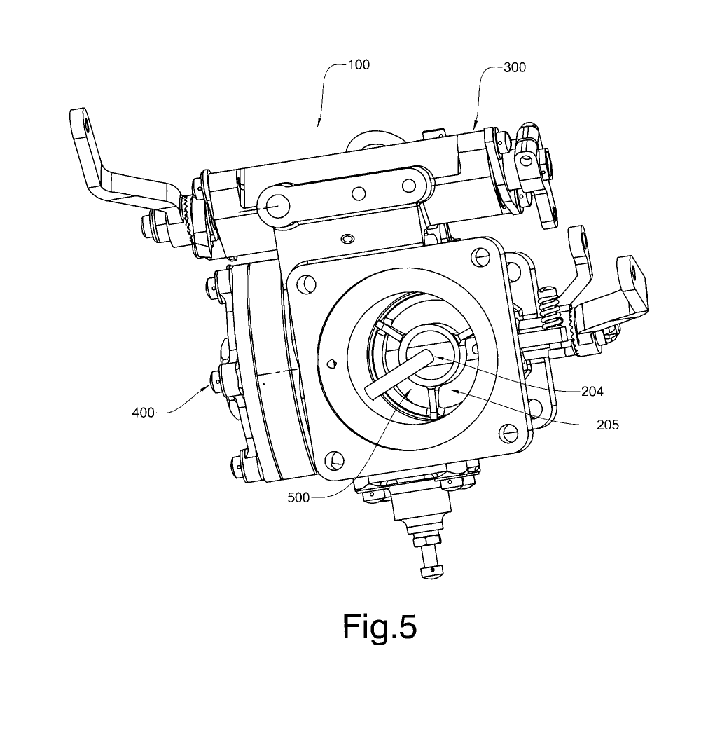

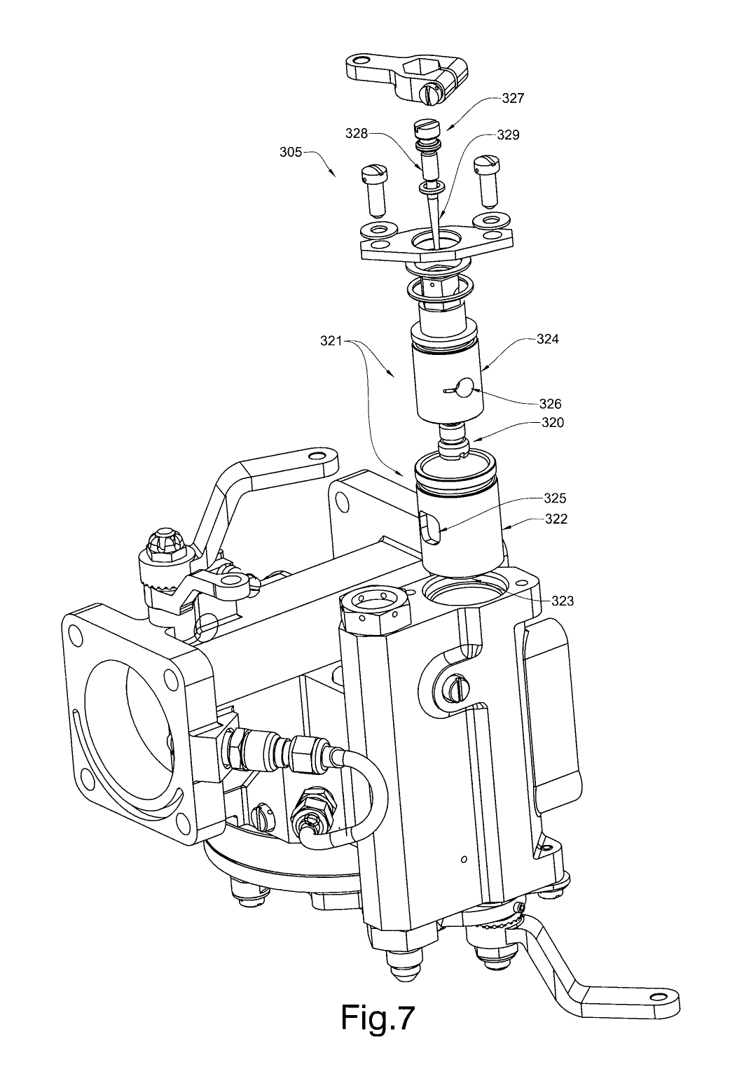

Referring to FIGS. 4 and 5, The Servo (100) comprises an air passage mechanism (“throttle body”) (200), a fuel pressure modifying mechanism (300), and a fuel metering mechanism (400). The throttle body (200) comprises a central section (210) that defines a plenum (205). The throttle body (200) further comprises a first end (201) and a second end (202). A venturi (500) is mounted within the plenum (205) at a location between the first end (201) and the second end (202). Also mounted within the plenum (205) is a throttle valve (204). The fuel pressure modifying mechanism (300) comprises a mixture control valve and an idle valve (305), as shown in FIG. 7.

The underlying principles of the Servo (100) are well known in the art. Generally, air flows through the throttle body (200) and works in combination with the venturi (500), fuel metering system (400), and other components to provide the proper amount of fuel to the combustion chambers of the engine. The amount of fuel received in the combustion chamber is directly proportionally to air flow. This is accomplished by channeling ambient air impact pressure and venturi suction pressure to opposite sides of an air diaphragm into the fuel metering system (400).

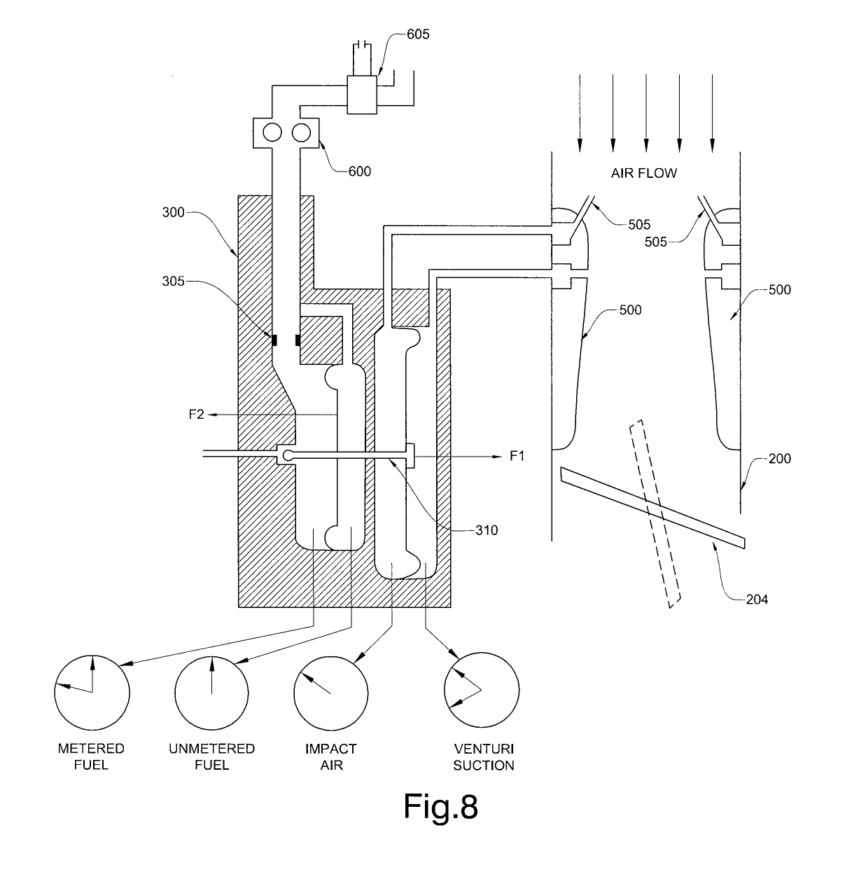

More specifically, referring to FIG. 8, fuel is supplied to the engine from the aircraft fuel system. This system usually comprises an engine driven pump (“fuel pump”) (600) and a boost pump (605) that supplies fuel, at a relatively constant pressure, to the pressure modifying mechanism (300).

Engine manufacturers specify the required fuel pump (600) pressure for a specific type of fuel injection servo. the fuel injection servo is calibrated at the servo inlet pressure. The fuel injection servo is tuned to assure that metered fuel flow will not be affected by changes in inlet fuel pressure caused by boost pump ON or OFF operations.

Air flow through the throttle body (200) generates an air pressure differential which is the difference between the impact pressure and the venturi suction pressure. This pressure differential applied across the air diaphragm exerts force F1. Fuel flow to the engine, passes through a main metering jet (305), generating a fuel pressure differential which is the difference between un-metered fuel and metered fuel pressure. This pressure deferential, applied across the fuel diaphragm exerts force F2.

When F1 is equal to F2, the servo valve (310) is held in a fixed position allowing discharge of enough metered fuel to maintain a pressure balance. If the throttle valve (204) is opened to increase power, air flow increases resulting in a increase pressure differential across the air diaphragm asserting a force of F1′. F1′ causes the servo valve (310) to move to the right causing a decrease in differential pressure across the fuel diaphragm which asserts a force F2′. When F2′ equals F1′, the system reaches a steady state condition described above. This sequence of operations is true over all power changes.

In this system, it is essential to have the largest differential pressure over the air diaphragm. One way to adjust the differential pressure is by adjusting the venturi (500).

FIGS. 1 and 1A shows a fuel injection servo that is well known in the art. As described above, a fuel injection servo can be tuned by changing the size of the venturi (500). This is difficult and time consuming.

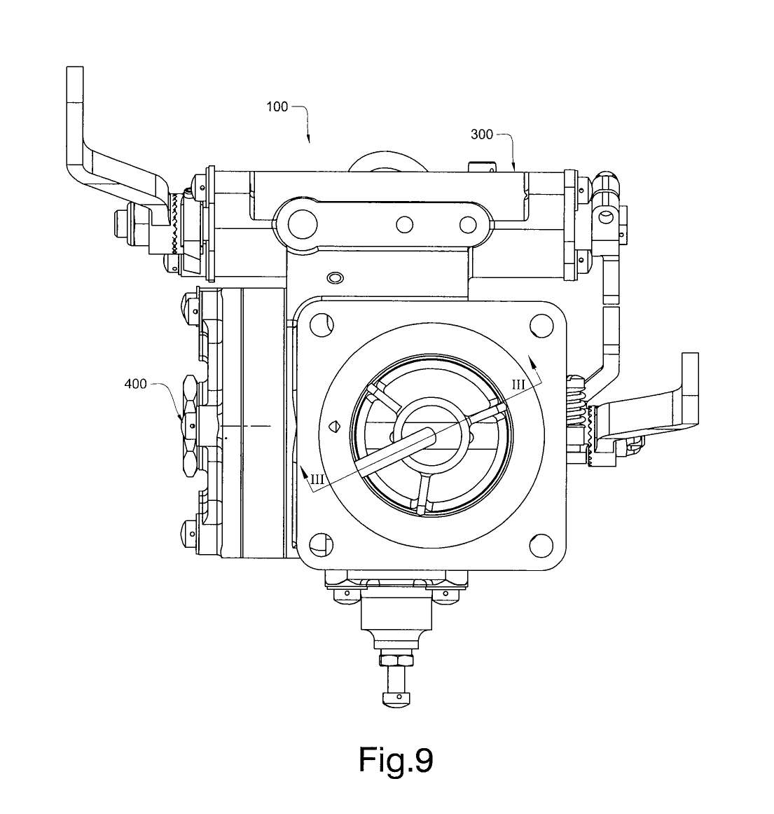

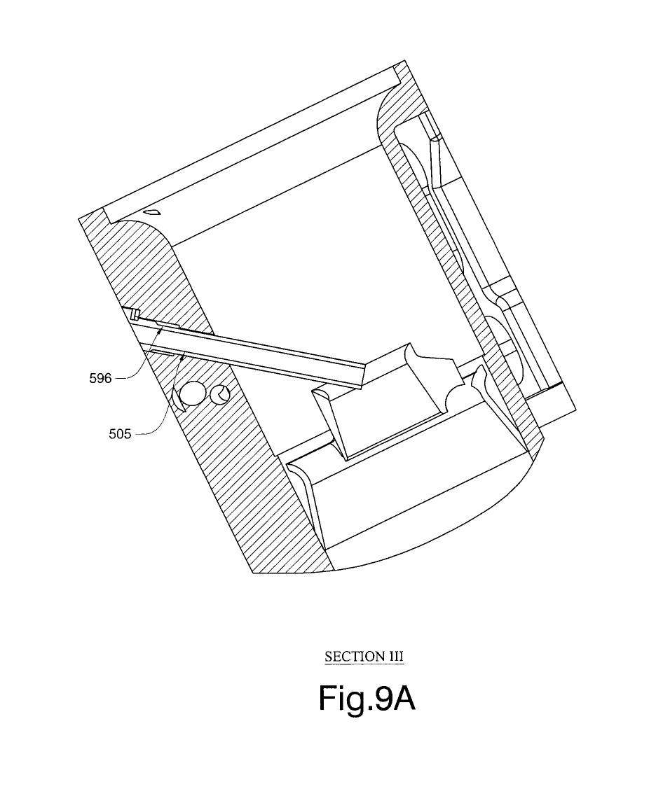

Referring to FIGS. 9 and 9A, the Servo (100) allows the manufacturer to easily adjust the differential air pressure over the air diaphragm. The Servo (100) has a single venturi suction tube (505) and a shim (506). The venturi suction tube (505) senses the venturi pressure. The shim (506) allows the manufacturer to make minor changes in the location of the venturi suction tube (505). Consequently, it is easier for the manufacturer to adjust the venturi pressure prior to leaving the factory.

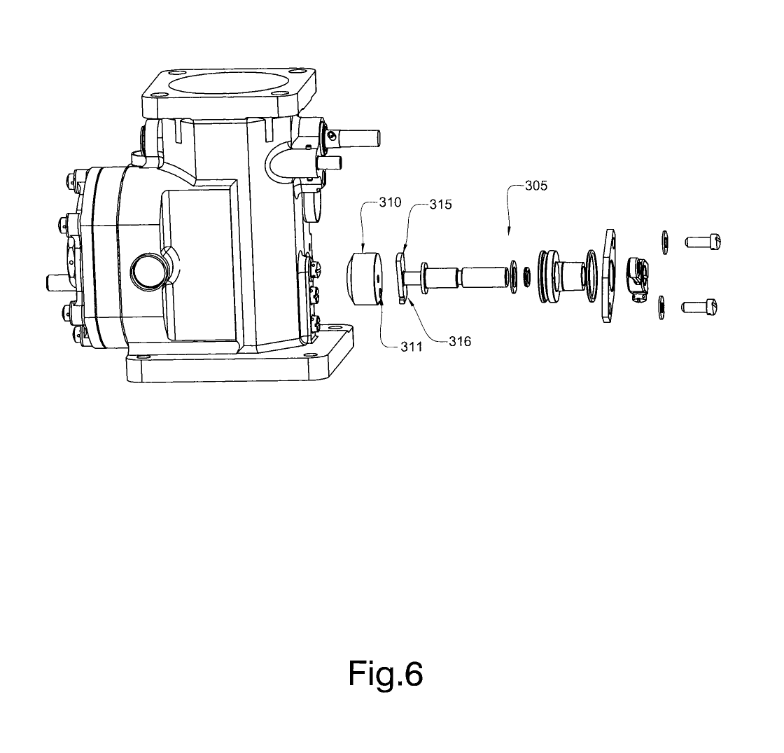

The amount of fuel received by the engine at lower speeds can be optimized by modifying the idle valve (305). FIG. 6 shows an exploded view of a idle valve (305) known in the art. The idle valve (305) comprises a metering jet (310) and a rotating plate (315). The metering jet (310) defines a metering jet hole (311) that allows fuel to flow into the Servo (100). The rotating plate (315) defines a notch (316). As the rotating plate (315) turns the size of the metering jet hole (311) changes depending on up the location of the notch (316).

FIG. 7 shows an exploded view of the idle valve (305) on the Servo (100). The idle valve (305) comprises a metering jet (320) and a means to modify the metering jet (328). The metering jet (320) screws into a barrel valve (321). The barrel valve (321) is comprised of a sleeve piece (322) and a barrel (324). The barrel (324) fits into the sleeve (322). The sleeve defines an outlet hole (325). The barrel defines a notched hole (326). The effective size of the outlet hole (325) is reduced depending on the location of the notched hole (326). That is when the notched holed (326) is lined up with the outlet hole (325), fuel flow through the metered jet (320) is at a maximum.

The means to modify the metering jet (328) comprises a needle valve (329). The needle valve (329) sits inside the barrel valve (321). Depending on the position of the needle valve (329) the effective size of the metering jet (320) can decrease thereby, decreasing the amount of fuel the engine receives. The position of the needle valve (329) is controlled by screw (327).

The screw (327) is accessible to the homebuilder, allowing the homebuilder to fine tune the amount of metered fuel entering the engine. Also, because of the smooth travel and minimal loading of the barrel valve (321), wear and tear is minimal. Additionally, if a component of the idle valve (305) wears, only that component would need to be replaced.

In a second embodiment, the Servo (100) is SPIS which replaces the carburetor of smaller aircraft. Carburetor flaws are discussed above. Homebuilders who prefer a fuel injection system can adapt a MPIS for their smaller aircraft. However, adaptation of a MPIS is not an ideal solution for the homebuilder.

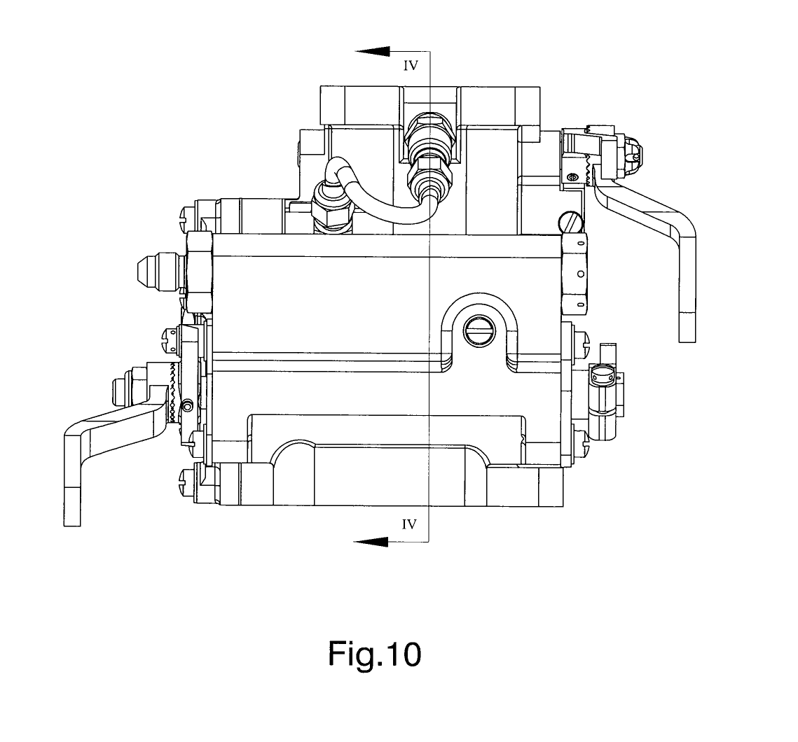

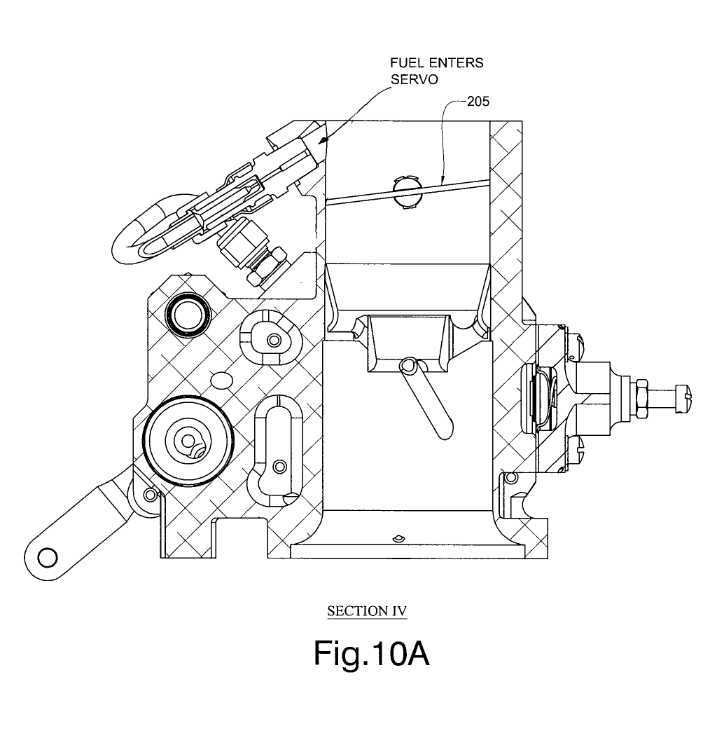

Carburetors, known in the art, receive fuel at a point above the throttle valve leaving fuel to vaporize causing icing on the carburetor and, in some cases, icing on the throttle valve. Referring to FIGS. 10 and 10A, fuel enters the Servo (100) at a position downstream the throttle valve (205).

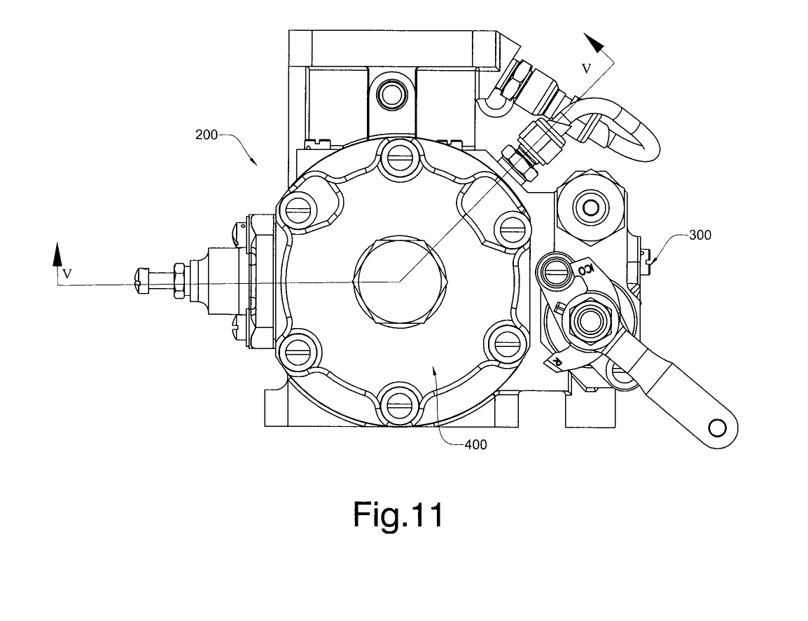

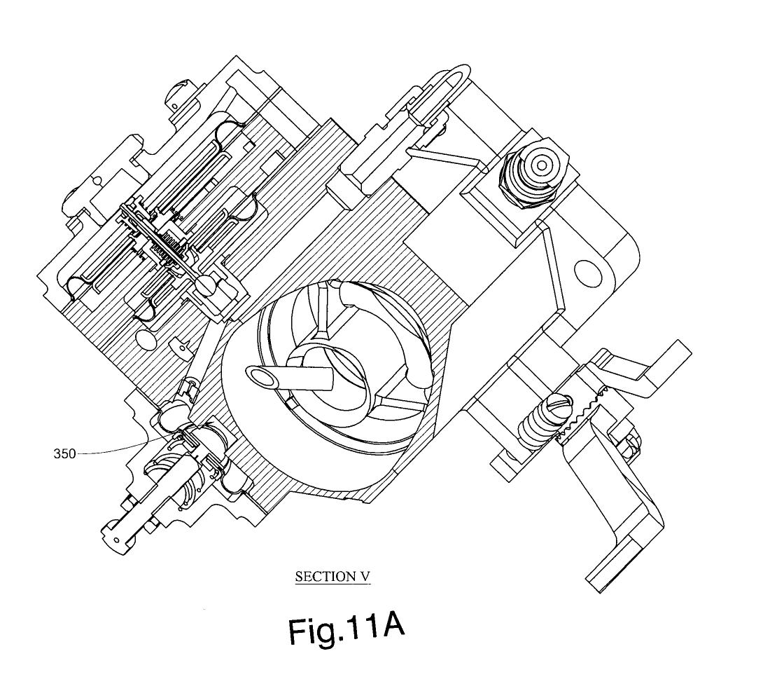

As discussed above, smaller aircraft have a delayed response at lift off (or acceleration). This is a natural occurrence in smaller aircraft because the fuel discharge is further away from the cylinders. Consequently, in the second embodiment, the fuel pressure modifying mechanism (300) further comprises an accelerator pump with a fuel reservoir (350) to compensate for the distance between the fuel discharge and the cylinder, as shown in FIGS. 11 and 11A.

Accelerator pumps are well known in the art. The greater inertia of liquid gasoline, compared to air means that if the throttle is suddenly opened, the airflow will increase more rapidly than the fuel flow, which can cause a temporary lean condition which causes the engine to stumble under acceleration. This is remedied by the use of an accelerator pump.

The fuel reservoir (350) holds a reserved amount of fuel to compensate for the distance between the outlet fuel and the cylinder. When the throttle valve (205) opens there exists an increase in the pressure differential across the air diaphragm which causes the servo valve (310) to open creating a sudden drop in metered fuel pressure and causing the reservoir (350) to empty. When the throttle valve (205) is still or is closing and the metered fuel stabilizes, the fuel reservoir (350) fills.

What is claimed is:

1. In a fuel injection system for and internal combustion engine, said fuel injection system comprising:
an air passage mechanism where said air passage mechanism comprises a central section, said central section defines a plenum allowing air passage through the air passage mechanism; said central section further comprises a bullet-type venturi valve and a throttle valve mounted within the plenum; flow of air through the air passage mechanism generates an air pressure differential which is the difference between impact pressure and venturi suction pressure
a fuel pressure modifying mechanism which receives fuel from a supply and delivers said fuel at a pressure different from said supply comprising a fuel regulator and an idle valve;
a fuel metering mechanism;
the improvement comprising:
(a) a means to tune said air pressure differential;
(b) an improved idle valve.

2. The fuel injection system of claim 1 where the means to tune said air pressure differential comprises a single venturi tube and a shim; said venturi tube is attached to said shim and said shim is mounted within the plenum where said shim allows minor adjustments in the location of the venturi suction tube.

3. The fuel injection system of claim 1 where the improved idle valve comprises a metering jet and a means to modify the metering jet.

4. The fuel injection system of claim 3 where the metering jet screws into a barrel valve; said barrel valve is comprised of a sleeve piece and a barrel where the barrel fits into the sleeve.

5. The fuel injection system of claim 4 where the sleeve defines an outlet hole and the barrel defines a notched hole; the effective size of the outlet hole is reduced depending on the location of the notched hole.

6. The fuel injection system of claim 5 where the means to modify the metering jet comprises a needle valve, said needle valve sits inside the barrel valve; the effective size of the metering jet depends upon the location of said needle valve.

7. The fuel injection system of claim 6 where the position of the needle valve is control by a screw.

8. In a fuel injection system for and internal combustion engine, said fuel injection system comprising:
an air passage mechanism where said air passage mechanism comprises a central section, said central section defines a plenum allowing air passage through the air passage mechanism; said central section further comprises a bullet-type venturi valve and a throttle valve mounted within the plenum; said flow of air through the air passage mechanism generates an air pressure differential which is the difference between impact pressure and venturi suction pressure
a fuel pressure modifying mechanism which receives fuel from a supply and delivers said fuel at a pressure different from said supply comprising a fuel regulator and an idle valve;
a fuel metering mechanism;
the improvement comprising:
(a) a means to adjust said air pressure differential;
(b) an improved idle valve;
(c) an accelerator pump;
(d) said fuel injection system receives fuel from a gas tank and delivers it to a position downstream of said throttle valve.

9. The fuel injection system of claim 8 where the means to tune said air pressure differential comprises a single venturi tube and a shim; said venturi tube is attached to said shim and said shim is mounted within the plenum; said shim allows minor adjustments in the location of the venturi suction tube

10. The fuel injection system of claim 8 where the improved idle valve comprises a metering jet and a means to modify the metering jet.

11. The fuel injection system of claim 10 where the metering jet screws into a barrel valve; said barrel valve is comprised of a sleeve piece and a barrel where the barrel fits into the sleeve.

12. The fuel injection system of claim 11 where the sleeve defines an outlet hole and the barrel defines a notched hole; the effective size of the outlet hole is reduced depending on the location of the notched hole.

13. The fuel injection system of claim 12 where the means to modify the metering jet comprises a needle valve, said needle valve sits inside the barrel valve; the effective size of the metering jet depends upon the location of said needle valve.

14. The fuel injection system of claim 13 where the position of the needle valve is control by a screw.

15. The fuel injection system of claim 8 where said accelerator pump comprises a fuel reservoir.

16. The fuel injection system of claim 15 where said fuel reservoir empties when an increase of differential pressure creates a sudden drop in metered fuel pressure.

17. The fuel injection system of claim 16 where said fuel reservoir fills when said throttle valve is still or closing and the amount of metered fuel pressure stabilizes.
